(19) United States
(12) Patent Application Publication
(10) Pub. No.: US 2011/0195315 A1
(43) Pub. Date: Aug. 11, 2011

(54) SOLID BATTERY

(75) Inventors: Yasushi TSUCHIDA, Susono-shi (JP); Yukiyoshi UENO, Gotenba-shi (JP); Shigenori HAMA, Susono-shi (JP); Kazunori TAKADA, Tsukuba-shi (JP)

(73) Assignees: TOYOTA JIDOSHA KABUSHIKI KAISHA, Toyota-shi (JP); NATIONAL INSTITUTE FOR MATERIALS SCIENCE, Tsukuba-shi (JP)

(21) Appl. No.: 13/022,064

(22) Filed: Feb. 7, 2011

(30) Foreign Application Priority Data
Feb. 9, 2010 (JP) 2010-026451

(51) Int. Cl. H01M 10/0562; H01M 10/056; B82Y 30/00

(52) U.S. Cl. 429/319; 429/304; 977/810

(57) ABSTRACT

A solid battery includes: a positive electrode active material layer that includes a positive electrode active material; a negative electrode active material layer that includes a negative electrode active material; and a solid electrolyte layer that is formed between the positive electrode active material layer and the negative electrode active material layer. A reaction suppressing portion made of an oxide of a group 4 metallic element is formed at an interface between the positive electrode active material and an amorphous non-bridging sulfide-based solid electrolyte material that does not substantially contain bridging sulfur.

### INCORPORATION BY REFERENCE

The disclosure of Japanese Patent Application No. 2010-026451 filed on Feb. 9, 2010 including the specification, drawings and abstract is incorporated herein by reference in its entirety.

### BACKGROUND OF THE INVENTION

1. Field of the Invention

The invention relates to a high-efficiency solid battery with less degradation of a solid electrolyte.

2. Description of the Related Art

With a rapid proliferation of information-related equipment and communication equipment, such as personal computers, camcorders and cellular phones, in recent years, it becomes important to develop a battery used as a power source of the information-related equipment or communication equipment. In addition, in automobile industry, and the like, development of high-power large-capacity batteries for electric vehicles or hybrid vehicles has been proceeding. Among various batteries, lithium batteries become a focus of attention in terms of high energy density.

Commercially available lithium batteries employ an electrolytic solution that contains a flammable organic solvent. Therefore, it is necessary to install a safety device that suppresses an increase in temperature in the event of a short circuit or to improve a structure or material for short-circuit prevention. In contrast to this, solid batteries that replace an electrolytic solution with a solid electrolyte layer do not use a flammable organic solvent in the batteries. For this reason, it is considered that the solid batteries contribute to simplification of a safety device and are excellent in manufacturing cost and productivity.

In the field of such solid batteries, in order to improve the performance of solid batteries, development in view of the interface between a positive electrode active material and a solid electrolyte material has been proceeding. For example, Narumi Ohta et al., “LiNbO₃-coated LiCoO₂ as cathode material for all solid-state lithium secondary batteries”, Electrochemistry Communications 9 (2007) 1486 to 1490 describes a solid battery. The solid battery uses a positive electrode active material coated with LiNbO₃, and uses an Li₂S—GeS₂—P₂S₅-based sulfide as a solid electrolyte material. In the solid battery, the positive electrode active material is coated with LiNbO₃ to thereby suppress the interface resistance between the positive electrode active material and the solid electrolyte material.

Then, Japanese Patent Application Publication No. 2008-027581 (JP-A-2008-027581) describes a solid battery. The solid battery uses an electrode subjected to surface treatment using sulfur or phosphorus to thereby improve ion conducting path at the interface between the electrode and a solid electrolyte layer.

In addition, Japanese Patent Application Publication No. 2001-052733 (JP-A-2001-052733) describes a sulfide-based solid battery. In the sulfide-based solid battery; a lithium chloride is supported on the surface of a positive electrode active material to thereby reduce the interface resistance between the positive electrode active material and a sulfide-based solid electrolyte material.

Furthermore, WO2007/004590 describes a solid battery. In this solid battery, the positive electrode active material of the solid battery described in Narumi Ohta et al. is coated with Li₄Ti₅O₁₂ having a chemical stability higher than that of LiNbO₃ and is used as a sulfide-based solid electrolyte material. This solid battery is presumed to more effectively suppress the interface resistance between the positive electrode active material and the solid electrolyte material than the solid battery described in Narumi Ohta et al. because of the high chemical stability of Li₄Ti₅O₁₂.

In addition, the sulfide-based solid electrolyte material has a high lithium ion conductivity, and it is useful to improve the performance of the solid battery. Therefore, various researches have been being conducted. Then, there is known that, among sulfide-based solid electrolyte materials, particularly, a sulfide-based solid electrolyte material that contains bridging sulfur has a high ion conductivity.

However, the sulfide-based solid electrolyte material that contains bridging sulfur is chemically instable, so, if this material is used for a solid battery, there is a problem that the solid electrolyte material reacts with another battery material, such as an active material, to be degraded. In addition, for example, when the positive electrode active material is coated with a reaction suppressing portion in a positive electrode layer as described in WO2007/004590, there is a problem that an electrode fracture occurs in the solid battery (fracture of the solid electrolyte material included in the solid battery) because of the hardness of the sulfide-based solid electrolyte material used for the solid battery.

### SUMMARY OF INVENTION

The invention provides a solid battery that exhibits less degradation of a sulfide-based solid electrolyte material and that is able to prevent an electrode fracture when a reaction suppressing portion is formed between a positive electrode active material and the sulfide-based solid electrolyte material.

A first aspect of the invention relates to a solid battery. The solid battery includes: a positive electrode active material layer that includes, a positive electrode active material; a negative electrode active material layer that includes a negative electrode active material; and a solid electrolyte layer that is formed between the positive electrode active material layer and the negative electrode active material layer. A reaction suppressing portion made of an oxide of a group 4 metallic element is formed at an interface between the positive electrode active material and an amorphous non-bridging sulfide-based solid electrolyte material that does not substantially contain bridging sulfur.

According to the above aspect, the above described non-bridging sulfide-based solid electrolyte material does not substantially contain bridging sulfur, so the non-bridging sulfide-based solid electrolyte material is chemically stable. Therefore, when the non-bridging sulfide-based solid electrolyte material is used it is possible to prevent degradation of the solid electrolyte material due to the reaction with another battery material, such as an active material.

In addition, the above described non-bridging sulfide-based solid electrolyte material is amorphous and soft, so the contact area between the solid electrolyte material and the positive electrode active material is increased to thereby make it possible to improve lithium ion conductivity and to prevent an electrode fracture.

Furthermore, the above described reaction suppressing portion is made of an oxide of a group 4 metallic element having a high electrochemical stability, so it is possible to prevent the reaction suppressing portion from reacting with the positive electrode active material or the non-bridging sulfide-based solid electrolyte material. Then, in the aspect of the invention, the non-bridging sulfide-based solid electrolyte material is soft, so the contact area between the solid electrolyte material and the positive electrode active material increases. Thus, the solid electrolyte material easily reacts with the positive electrode active material. Therefore, the reaction suppressing portion effectively suppresses the reaction between the non-bridging sulfide-based solid electrolyte material and the positive electrode active material. This effectively suppresses the interface resistance between the positive electrode active material and the non-bridging sulfide-based solid electrolyte material.

According to the above aspect, it is possible to prevent degradation of the solid electrolyte material of the solid battery. In addition, it is possible to improve the lithium conductivity of the solid battery and to prevent an electrode fracture.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a view that illustrates an example of a power generating element of a solid battery according to an embodiment of the invention;

FIG. 2A to FIG. 2D are schematic sectional views that respectively illustrate reaction suppressing portions according to the embodiment of the invention; and

FIG. 3A to FIG. 3D are schematic sectional views that respectively illustrate reaction suppressing portions according to the embodiment of the invention.

### DETAILED DESCRIPTION OF EMBODIMENT

Hereinafter, a solid battery according to an embodiment of the invention will be described in detail.

The solid battery according to the embodiment of the invention includes a positive electrode active material layer that includes a positive electrode active material, a negative electrode active material layer that includes a negative electrode active material and a solid electrolyte layer that is formed between the positive electrode active material layer and the negative electrode active material layer. In the solid battery, a reaction suppressing portion made of an oxide of a group 4 metallic element is formed at an interface between the positive electrode active material and an amorphous non-bridging sulfide-based solid electrolyte material that does not substantially contain bridging sulfur.

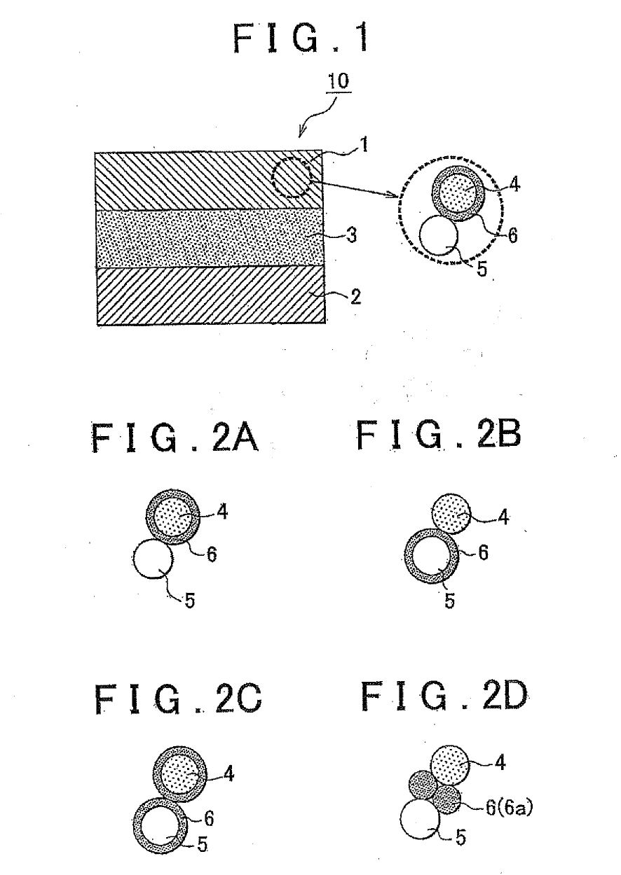

FIG. 1 is a view that illustrates a power generating element of the solid battery according to the embodiment of the invention. The power generating element 10 of the solid battery shown in FIG. 1 includes a positive electrode active material layer 1, a negative electrode active material layer 2 and a solid electrolyte layer 3. The solid electrolyte layer 3 is formed between the positive electrode active material layer 1 and the negative electrode active material layer 2. Then, the positive electrode active material layer 1 includes a positive electrode active material 4, a non-bridging sulfide-based solid electrolyte material 5 and a reaction suppressing portion 6. The reaction suppressing portion 6 is formed at the interface between the positive electrode active material 4 and the non-bridging sulfide-based solid electrolyte material 5. The reaction suppressing portion 6 is formed so as to coat the surface of the positive electrode active material 4, and is made of an oxide of a group 4 metallic element (for example, Li₄Ti₅O₁₂). In addition, the non-bridging sulfide-based solid electrolyte material 5 is an amorphous material that does not substantially contain bridging sulfur.

According to the embodiment of the invention, the above described non-bridging sulfide-based solid electrolyte material does not substantially contain bridging sulfur, so the non-bridging sulfide-based solid electrolyte material is chemically stable. Therefore, when the non-bridging sulfide-based solid electrolyte material is used, it is possible to prevent degradation of the non-bridging sulfide-based solid electrolyte material due to the reaction with another battery material, such as an active material.

In addition, the above described non-bridging sulfide-based solid electrolyte material is amorphous and soft, so the contact area between the solid electrolyte material and the positive electrode active material is increased to thereby make it possible to improve lithium ion conductivity and to prevent an electrode fracture.

Furthermore, the above described reaction suppressing portion is made of an oxide of a group 4 metallic element having a high electrochemical stability, so the reaction suppressing portion is able to suppress the reaction between the positive electrode active material and the non-bridging sulfide-based solid electrolyte material. Then, in the embodiment of the invention, the non-bridging sulfide-based solid electrolyte material is soft, so the area in which the non-bridging sulfide-based solid electrolyte material is in contact with the positive electrode active material increases, and the non-bridging sulfide-based solid electrolyte material easily reacts with the positive electrode active material. Therefore, the reaction suppressing portion effectively suppresses the reaction between the non-bridging sulfide-based solid electrolyte material and the positive electrode active material. This effectively suppresses the interface resistance between the positive electrode active material and the non-bridging sulfide-based solid electrolyte material through the reaction between the non-bridging sulfide-based solid electrolyte material and the positive electrode active material.

Hereinafter, the solid battery according to the embodiment of the invention will be described component by component.

The positive electrode active material layer according to the embodiment of the invention will be described. The positive electrode active material layer according to the embodiment of the invention includes at least the positive electrode active material, and, where necessary, may include at least one of a solid electrolyte material and a conducting material. Particularly, in the embodiment of the invention, the solid electrolyte material included in the positive electrode active material layer may be an amorphous non-bridging sulfide-based solid electrolyte material that does not substantially contain bridging sulfur. This is because the amorphous non-bridging sulfide-based solid electrolyte material does not substantially contain bridging sulfur and, therefore, the amorphous non-bridging sulfide-based solid electrolyte material is chemically stable. In addition, the solid electrolyte material is amorphous and soft, so it is possible to improve lithium ion conductivity and to prevent an electrode fracture. This is also because the solid electrolyte material is based on a sulfide-based material and, therefore, the solid electrolyte material has a high ion conductivity and is able to improve the ion conductivity of the positive electrode active material layer. In addition, when the positive electrode active material layer includes both the positive electrode active material and the non-bridging sulfide-based solid electrolyte material, the reaction suppressing portion made of an oxide of a group 4 metallic element is also formed in the positive electrode active material layer.

The positive electrode active material used in the embodiment of the invention will be described. The positive electrode active material used in the embodiment of the invention varies depending on the type of conducting ions of an intended solid battery. For example, when the solid battery according to the embodiment of the invention is a solid lithium battery, the positive electrode active material occludes or releases lithium ions. In addition, the positive electrode active material used in the embodiment of the invention generally reacts with the non-bridging sulfide-based solid electrolyte material (described later) to form a high-resistance layer.

The positive electrode active material used in the embodiment of the invention is not specifically limited as long as it reacts with the non-bridging sulfide-based solid electrolyte material to form a high-resistance layer. For example, the positive electrode active material may be an oxide-based positive electrode active material. The oxide-based positive electrode active material is used to make it possible to obtain a solid battery having a high energy density.

The oxide-based positive electrode active material used for a solid lithium battery may be, for example, a positive electrode active material expressed by general formula LiₓM_{y}O_{z} (where M is a transition metallic element, x=0.02 to 2.2, y=1 to 2 and z=1.4 to 4). In the above general formula, M may be at least one selected from the group consisting of Co, Mn, Ni, V, Fe and Si, and may be at least one selected from the group consisting of Co, Ni and Mn.

The above oxide-based positive electrode active material may be, specifically, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, Li₂FeSiO₄, Li₂MnSiO₄, or the like. In addition, the positive electrode active material other than the above general formula LiₓM_{y}O_{z} may be an olivine positive electrode active material, such as LiFePO₄ and LiMnPO₄.

The shape of the positive electrode active material may be, for example, a particulate shape. The shape of the positive electrode active material may be a spherical shape or an ellipsoidal shape. In addition, when the positive electrode active material has a particulate shape, the mean particle diameter may, for example, range from 0.1 μm to 50 μm.

The content of the positive electrode active material in the positive electrode active material layer desirably, for example, ranges from 10 percent by weight to 99 percent by weight, and may range from 20 percent by weight to 90 percent by weight.

In the embodiment of the invention, the positive electrode active material layer may include the amorphous sulfide-based solid electrolyte material that does not substantially contain bridging sulfur, that is, the non-bridging sulfide-based solid electrolyte material. Because the solid electrolyte material does not substantially contain bridging sulfur, the solid electrolyte material is chemically stable, and is amorphous and soft, so the solid electrolyte material contributes to preventing an electrode fracture and improvement in battery efficiency.

The non-bridging sulfide-based solid electrolyte material according to the embodiment of the invention may contain Li, one of group 13 to group 15 elements, S, and may include an MSₓ unit (M is one of group 13 to group 15 elements, S is a sulfur element, x is the number of sulfur elements that can be bonded with M).

Then, the non-bridging sulfide-based solid electrolyte material according to the embodiment of the invention may be made from a material composition that contains Li₂S and a sulfide of one of group 13 to group 15 elements. Thus, it is possible to obtain the non-bridging sulfide-based solid electrolyte material that has a lithium ion conductivity.

Li₂S contained in the above described material composition may contain few impurities. This is because Li₂S containing fewer impurities is able to suppress side reaction. A method of synthesizing Li₂S may be, for example, the method described in Japanese Patent Application Publication No. 7-330312 (JP-A-7-330312). Furthermore, Li₂S may be purified by, for example, the method described in International Patent Application Publication No. WO2005/040039, or the like. On the other hand, a sulfide of one of group 13 to group 15 elements, contained in the above described material composition, may be, for example, P₂S₃, P₂S₅, SiS₂, GeS₂, As₂S₃, Sb₂S₃, Al₂S₃, or the like.

In addition, the non-bridging sulfide-based solid electrolyte material according to the embodiment of the invention does not substantially contain bridging sulfur as one of characteristics. Here, the “bridging sulfur” is a bridging sulfur in a chemical compound that is formed by the reaction between Li₂S and a sulfide of one of group 13 to group 15 elements. For example, a bridging sulfur in an S₃P—S—PS₃ unit formed by the reaction between Li₂S and P₂S₅ corresponds to the “bridging sulfur”. Whether the non-bridging sulfide-based solid electrolyte material according to the embodiment of the invention does not substantially contain bridging sulfur depends on the proportion of Li₂S contained in the above described material composition. Then, whether the non-bridging sulfide-based solid electrolyte material substantially contains bridging sulfur may be determined, for example, through Raman spectroscopy, or the like. For example, in the case of an Li₂S—P₂S₅-based non-bridging sulfide-based solid electrolyte material, it is desirable that there is no peak of S₃P—S—PS₃. the peak of S₃P—S—PS₃ generally appears at 402 cm⁻¹. Therefore, in the embodiment of the invention, it is desirable that the above peak is not detected. In addition, the peak of PS₄ generally appears at 417 cm⁻¹. In the embodiment of the invention, the intensity I₄₀₂ at 402 cm⁻¹ may be lower than the intensity I₄₁₇ at 417 cm⁻¹. More specifically, for example, the intensity I₄₀₂ may be lower than or equal to 70% of the intensity I₄₁₇, may be lower than or equal to 50% of the intensity I₄₁₇, and may be lower than or equal to 35% of the intensity I₄₁₇.

Then, the non-bridging sulfide-based solid electrolyte material according to the embodiment of the invention may have a characteristic such that the non-bridging sulfide-based solid electrolyte material does not substantially contain Li₂S. The fact that the non-bridging sulfide-based solid electrolyte material does not substantially contain Li₂S means that the non-bridging sulfide-based solid electrolyte material does not substantially contain Li₂S derived from a starting material. Li₂S easily reacts with water to thereby easily produce hydrogen sulfide. In the embodiment of the invention, when the proportion of Li₂S in the above described material composition is excessively high, the non-bridging sulfide-based solid electrolyte material contains Li₂S. The fact that the non-bridging sulfide-based solid electrolyte material does not substantially contain Li₂S may be, for example, confirmed through X-ray diffraction. Specifically, when there is no peak (2θ=27.0°, 31.2°, 44.8°, 53.1°) of Li₂S, it may be determined that the non-bridging sulfide-based solid electrolyte material does not substantially contain Li₂S.

Then, in the embodiment of the invention, the proportion of Li₂S contained in the above described material composition is not specifically limited as long as the proportion of Li₂S is a proportion at which it is possible to obtain the non-bridging sulfide-based solid electrolyte material that does not substantially contain bridging sulfur. Particularly, the proportion of Li₂S contained in the above described material composition is a proportion at which it is possible to obtain the non-bridging sulfide-based solid electrolyte material that also does not substantially contain Li₂S. When the non-bridging sulfide-based solid electrolyte material according to the embodiment of the invention does not substantially contain bridging sulfur or Li₂S, the non-bridging sulfide-based solid electrolyte material generally has an ortho composition or a composition close to the ortho composition. Here, the ortho generally indicates an oxoacid that has the highest degree of hydration among oxoacids obtained by hydrating the Same oxide. In the embodiment of the invention, a crystal composition of a sulfide having a largest amount of Li₂S added is called ortho composition.

When the above described material composition contains Li₂S and P₂S₅, the above described material composition may contain only Li₂S and P₂S₅ or may further contain another chemical compound. The ratio of Li₂S and P₂S₅ may range from 70:30 to 85:15, may range from 70:30 to 80:20 and may range from 72:28 to 78:22 on a molar basis. When the ratio of Li₂S and P₂S₅ falls within the range that includes a ratio (Li₂S:P₂S₅=75:25) that gives an ortho composition and a ratio close to that ratio, it is possible to reduce the amount of hydrogen sulfide produced.

Furthermore, the non-bridging sulfide-based solid electrolyte material according to the embodiment of the invention is amorphous as one of characteristics. In order to obtain the amorphous non-bridging sulfide-based solid electrolyte material, it is only necessary to carry out amorphization using the above described material composition. Amorphization may be, for example, mechanical milling or melt extraction. Mechanical milling may be performed at room temperature to thereby make it possible to simplify the manufacturing process. Then, whether the non-bridging sulfide-based solid electrolyte material is amorphous may be, for example, determined through. X-ray diffraction (XRD) analysis, electron diffraction analysis, or the like.

In addition, the non-bridging sulfide-based solid electrolyte material according to the embodiment of the invention contains one of group 13 to group 15 elements, and may contain a group 14 or group 15 element. Thus, it is possible to obtain a sulfide-based solid electrolyte material having a small amount of hydrogen sulfide produced. The group 14 or group 15 element is not specifically limited; however, for example, the non-bridging sulfide-based solid electrolyte material may contain an element, such as phosphorus (P), silicon (Si) and germanium (Ge). When the non-bridging sulfide-based solid electrolyte material contains phosphorus (P), the non-bridging sulfide-based solid electrolyte material is further soft and has a further improved ion conductivity, and is able to further effectively prevent an electrode fracture. Then, whether the non-bridging sulfide-based solid electrolyte material contains phosphorus (P) may be, for example, determined through. NMR, Raman spectroscopy, energy dispersive X-ray spectroscopy, or the like.

Furthermore, when the non-bridging sulfide-based solid electrolyte material contains phosphorus (P), a material composition that contains Li₂S and P₂S₅ may be used. By so doing, the non-bridging sulfide-based solid electrolyte material is further soft and is able to further effectively prevent an electrode fracture (fracture of the solid electrolyte material included in the solid battery).

In addition, the shape of the non-bridging sulfide-based solid electrolyte material may be, for example, a particulate shape. The shape of the non-bridging sulfide-based solid electrolyte material may also be a spherical shape or an ellipsoidal shape. In addition, when the non-bridging sulfide-based solid electrolyte material has a particular shape, the mean particle diameter, for example, ranges from 0.1 μm to 50 μm. The content of the non-bridging sulfide-based solid electrolyte material in the positive electrode active material layer may, for example, range from 1 percent by weight to 90 percent by weight, and may range from 10 percent by weight to 80 percent by weight.

In the embodiment of the invention, when the positive electrode active material layer contains both the positive electrode active material and the non-bridging sulfide-based solid electrolyte material, generally, the reaction suppressing portion made of an oxide of a group 4 metallic element is also formed in the positive electrode active material layer. This is because the reaction suppressing portion needs to be formed at the interface between the positive electrode active material and the non-bridging sulfide-based solid electrolyte material. The reaction suppressing portion has the function of suppressing the reaction between the positive electrode active material and the non-bridging sulfide-based solid electrolyte material. The reaction occurs while the battery is being used. The oxide of a group 4 metallic element, which constitutes the reaction suppressing portion, has an electrochemical stability higher than that of a niobium oxide (for example, LiNbO₃) that is known as a material that constitutes the reaction suppressing portion, so it is possible to suppress an increase in the interface resistance over time.

First, the oxide of a group 4 metallic element, which constitutes the reaction suppressing portion, will be described. The oxide of a group 4 metallic element according to the embodiment of the invention at least contains a group 4 metallic element and an oxide element bonded with the metallic element. In the embodiment of the invention, the group 4 metallic element may be titanium or zirconium. This is because titanium and zirconium each are a general-purpose transition metallic element that produces an oxide having a high electrochemical stability. The oxide of a group 4 metallic element may be, for example, TiO₂, ZrO₂, or the like. In addition, the oxide of a group 4 metallic element may contain both titanium and zirconium.

In the embodiment of the invention, the oxide of a group 4 metallic element may further contain a metallic element that becomes a conducting ion. By so doing, the oxide of a group 4 metallic element has an excellent ion conductivity. The metallic element varies depending on the type of an intended solid battery. The metallic element may be, for example, alkali metal, such as Li and Na, or alkali earth metal, such as Mg and Ca. That is, when the solid battery according to the embodiment of the invention is a solid lithium battery, the above described metallic element that becomes a conducting ion may be Li. By so doing, it is possible to obtain a solid lithium battery that suppresses an increase in the interface resistance over time. The oxide of a group 4 metallic element, which contains Li, may be, for example, Li₄Ti₅O₁₂, LiTiO₃, Li₂ZrO₃, or the like. Li₄Ti₅O₁₂ has a particularly excellent ion conductivity.

In addition, the content of the oxide of a group 4 metallic element in the positive electrode active material layer may, for example, range from 0.1 percent by weight to 20 percent by weight, and may range from 0.5 percent by weight to 10 percent by weight.

Next, the form of the reaction suppressing portion in the positive electrode active material layer will be described. In the embodiment of the invention, when the positive electrode active material layer includes the non-bridging sulfide-based solid electrolyte material, the reaction suppressing portion made of the oxide of a group 4 metallic element is generally formed in the positive electrode active material layer. The form of the reaction suppressing portion in this case may be, for example, as shown in FIG. 2A to FIG. 2C, a form in which the reaction suppressing portion 6 is formed so as to coat the surface of the positive electrode active material 4 (FIG. 2A), a form in which the reaction suppressing portion 6 is formed so as to coat the surface of the non-bridging sulfide-based solid electrolyte material 5 (FIG. 2B), a form in which the reaction suppressing portion 6 is formed so as to coat both the surface of the positive electrode active material 4 and the surface of the non-bridging sulfide-based solid electrolyte material 5, or the like. When the reaction suppressing portion is formed so as to coat the surface of the positive electrode active material, because the positive electrode active material is harder than the non-bridging sulfide-based solid electrolyte material, the reaction suppressing portion that coats the positive electrode active material is hard to peel off.

Note that, even when the positive electrode active material, the non-bridging sulfide-based solid electrolyte material and the oxide of a group 4 metallic element are just simply mixed with one another, oxides 6a of a group 4 metallic element may be arranged at the interface between the positive electrode active material 4 and the non-bridging sulfide-based solid electrolyte material 5 to form the reaction suppressing portion 6. In this case, the effect of suppressing an increase in the interface resistance over time is slightly poor; however, it is advantageous that the manufacturing process of the positive electrode active material layer is simplified.

In addition, the reaction suppressing portion that coats the positive electrode active material or the non-bridging sulfide-based solid electrolyte material may have a thickness to an extent such that these materials do not react with each other. The thickness of the reaction suppressing portion may, for example, range from 1 nm to 500 nm, and may range from 2 nm to 100 nm.

If the thickness of the reaction suppressing portion is too small, there is a possibility that the positive electrode active material reacts with the non-bridging sulfide-based solid electrolyte material. If the thickness of the reaction suppressing portion is too large, there is a possibility that the ion conductivity decreases. In addition, the reaction suppressing portion may coat a surface area of the positive electrode active material, or the like, as much as possible, and may coat all the surface of the positive electrode active material, or the like. By so doing, it is possible to effectively suppress an increase in the interface resistance over time.

A method of forming the reaction suppressing portion according to the embodiment of the invention may be appropriately selected on the basis of the above described form of the reaction suppressing portion. For example, when the reaction suppressing portion that coats the positive electrode active material is formed, the method of forming the reaction suppressing portion may be, for example, a method in which a material composition that has a material chemical compound that contains a group 4 metallic element is applied onto the positive electrode active material and then the positive electrode active material to which the material composition is applied is subjected to heat treatment in the atmosphere. A method of applying the material composition may be, for example, a method that uses a coater having a rolling fluidized layer. In addition, another example of a method of forming the reaction suppressing portion may be mechanofusion, CVD, PVD, or the like.

The positive electrode active material layer according to the embodiment of the invention may further include a conducting material. By adding the conducting material, it is possible to improve the conductivity of the positive electrode active material layer. The conducting material is, for example, acetylene black, Ketjen black, carbon fiber, or the like. In addition, the content of the conducting material in the positive electrode active material layer is not specifically limited. The content of the conducting material may, for example, range from 0.1 percent by weight to 20 percent by weight. In addition, the thickness of the positive electrode active material layer varies depending on the type of an intended solid battery. The thickness of the positive electrode active material layer may, for example, range from 1 μm to 100 μm.

Next, the solid electrolyte layer according to the embodiment of the invention will be described. The solid electrolyte layer according to the embodiment of the invention at least includes a solid electrolyte material. As described above, when the positive electrode active material layer includes the non-bridging sulfide-based solid electrolyte material, the solid electrolyte material used for the solid electrolyte layer is not specifically limited; instead, the solid electrolyte material may be a non-bridging sulfide-based solid electrolyte material or may be a solid electrolyte material other than that. On the other hand, when the positive electrode active material layer does not include the non-bridging sulfide-based solid electrolyte material, the solid electrolyte layer generally includes the non-bridging sulfide-based solid electrolyte material. Particularly, in the embodiment of the invention, both the positive electrode active material layer and the solid electrolyte layer may include the non-bridging sulfide-based solid electrolyte material. By so doing, the solid battery has an excellent ion conductivity. In addition, the solid electrolyte material used for the solid electrolyte layer may be only the non-bridging sulfide-based solid electrolyte material.

Note that the non-bridging sulfide-based solid electrolyte material is similar to that described for the positive electrode active material layer. In addition, the solid electrolyte material other than the non-bridging sulfide-based solid electrolyte material may be a material similar to the solid electrolyte material used for a general solid battery, and may b; for example, an Oxide-based solid electrolyte material.

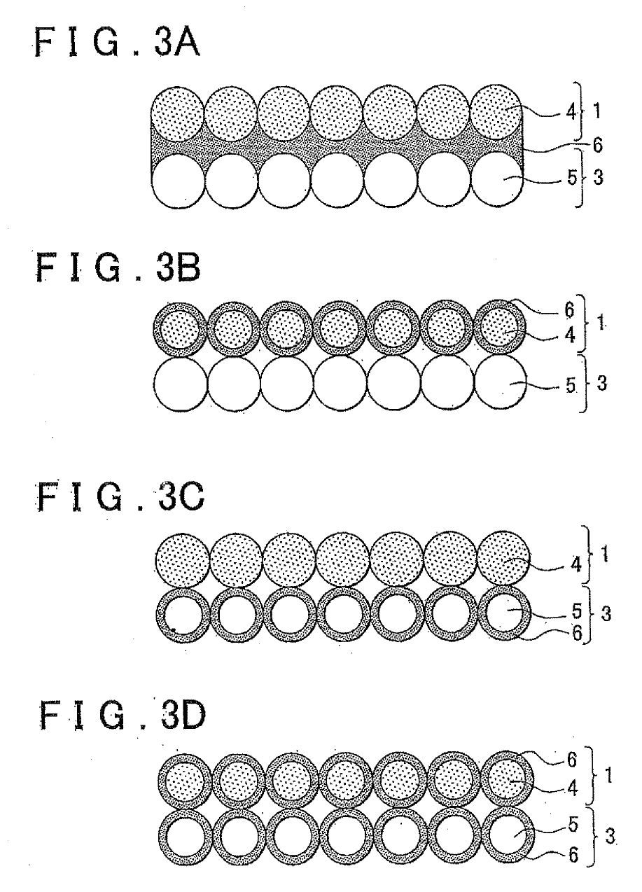

In the embodiment of the invention, when the solid electrolyte layer includes the non-bridging sulfide-based solid electrolyte material, the reaction suppressing portion made of a group 4 metallic element is generally formed in the positive electrode active material layer, in the solid electrolyte layer or at the interface between the positive electrode active material layer and the solid electrolyte layer. The form of the reaction suppressing portion in this case may be, for example, as shown in FIG. 3A to FIG. 3D, a form in which the reaction suppressing portion 6 is formed at the interface between the positive electrode active material layer 1 that includes the positive electrode active material 4 and the solid electrolyte layer 3 that includes the non-bridging sulfide-based solid electrolyte material 5 (FIG. 3A), a form in which the reaction suppressing portion 6 is formed so as to coat the surface of the positive electrode active material 4 (FIG. 3B), a form in which the reaction suppressing portion 6 is formed so as to coat the surface of the non-bridging sulfide-based solid electrolyte material 5 (FIG. 3C), a form in which the reaction suppressing portion 6 is formed so as to coat the surface of the positive electrode active material 4 and the surface of the non-bridging sulfide-based solid electrolyte material 5 (FIG. 3D), or the like. When the reaction suppressing portion is formed so as to coat the surface of the positive electrode active material, the positive electrode active material is harder than the non-bridging sulfide-based solid electrolyte material, so the reaction suppressing portion that coats the positive electrode active material is hard to peel off.

The thickness of the solid electrolyte layer according to the embodiment of the invention may, for example, range from 0.1 μm to 1000 μm, and may range from 0.1 μm to 300 μm.

Next, the negative electrode active material layer according to the embodiment of the invention will be described. The negative electrode active material layer according to the embodiment of the invention at least includes a negative electrode active material and, where necessary, may include at least one of a solid electrolyte material and a conducting material. The negative electrode active material varies depending on the type of conducting ion of an intended solid battery. The negative electrode active material may be a metal active material or a carbon active material. The metal active material may be, for example, In, Al, Si, Sn, or the like.

On the other hand, the carbon active material may be, for example, mesocarbon microbead (MCMB), highly oriented graphite (HOPG), hard carbon, soft carbon, or the like.

Note that the solid electrolyte material and conducting material used for the negative electrode active material layer are similar to those in the case of the above described positive electrode active material layer. In addition, the thickness of the negative electrode active material layer, for example, ranges from 0.1 μm to 1000 μm.

The solid battery according to the embodiment of the invention at least includes the above described positive electrode active material layer, solid electrolyte layer and negative electrode active material layer. Furthermore, generally, the solid battery includes a positive electrode current collector and a negative electrode current collector. The positive electrode current collector collects current from the positive electrode active material layer. The negative electrode current collector collects current from the negative electrode active material layer. The material of the positive electrode current collector may be, for example, stainless steel, aluminum, nickel, iron, titanium, carbon, or the like. On the other hand, the material of the negative electrode current collector may be, for example, stainless steel, copper, nickel, carbon, or the like. In addition, the thickness, shape, and the like, of each of the positive electrode current collector and the negative electrode current collector may be selected appropriately on the basis of an application, or the like, of the solid battery. In addition, a battery case used in the embodiment of the invention may be a typical battery case for a solid battery. The battery case may be, for example, a stainless steel battery case, or the like. In addition, the solid battery according to the embodiment of the invention may be one in which a power generating element is formed inside an insulating ring.

In the embodiment of the invention, the reaction suppressing portion made of an oxide of a group 4 metallic element having a high electrochemical stability is used, so the type of conducting ion is not specifically limited. The type of solid battery according to the embodiment of the invention may be a solid lithium battery, a solid sodium battery, a solid magnesium battery, a solid calcium battery, or the like. In addition, the solid battery according to the embodiment of the invention may be a primary battery or a secondary battery. When the solid battery is a secondary battery, the solid battery may be repeatedly charged or discharged, and is useful in, for example, an in-vehicle battery. The shape of the solid battery according to the embodiment of the invention may be, for example, a coin shape, a laminated shape, a cylindrical shape, a square shape, or the like.

In addition, a method of manufacturing the solid battery according to the embodiment of the invention is not specifically limited as long as the above described solid battery may be obtained. The method of manufacturing the solid battery may be a method similar to a typical method of manufacturing a solid battery. An example of the method of manufacturing the solid battery may be a method in which a power generating element is prepared by sequentially pressing a material that constitutes the positive electrode active material layer, a material that constitutes the solid electrolyte layer and a material that constitutes the negative electrode active material layer, the power generating element is accommodated inside a battery case and then the battery case is crimped.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

Hereinafter, the embodiment of the invention will be more specifically described with reference to Examples.

### Example 1

Manufacturing Material Made by Coating LiCoO₂ with Li₄Ti₅O₁₂

First, in ethanol, lithium ethoxide and titanium isopropoxide were mixed at the mole ratio of 4:5. Subsequently, the obtained solution was applied by a coater having a rolling fluidized layer onto the positive electrode active material (LiCoO₂) so as to have a thickness of 5 nm, and was then dried by hot air. After that, the obtained powder was subjected to heat treatment in the atmosphere at 400° C. for 30 minutes to obtain a material made by coating LiCoO₂ with Li₄Ti₅O₁₂.

### Manufacturing Solid Electrolyte Material 75Li₂S-25P₂S₅

Lithium sulfide (Li₂S) and phosphorus pentasulfide (P₂S₅) were used as starting materials. The powder of Li₂S and the powder of P₂S₅ were placed in a glove box in an atmosphere of argon, and were weighted to obtain the mole ratio of x=75 in the composition of xLi₂S.(100−x)P₂S₅ and were then mixed in an agate mortar to thereby obtain a material composition. Then, 1 g of the obtained material composition was put into a 45 ml zirconia pot, zirconia balls (φ10 mm, 10 balls) were further put into the pot and then the pot was completely hermetically sealed. The pot was mounted on a planetary ball milling machine. Then, mechanical milling was performed at a rotational speed of 370 rpm for 40 hours. After that, the solid electrolyte material 75Li₂S-25P₂S₅ was obtained.

### Manufacturing All-solid Lithium Secondary Battery

First, the above described material made by coating LiCoO₂ with Li₄Ti₅O₁₂ and the above described solid electrolyte material were mixed at the ratio by weight of 7:3 to thereby obtain a positive electrode mixture. Subsequently, graphite and the solid electrolyte material were mixed at the ratio by weight of 5:5 to thereby obtain a negative electrode mixture. Then, a pressing machine was used to prepare the above described power generating element 10 as Shown in FIG. 1. The above described positive electrode mixture was used as a material that constitutes the positive electrode active material layer 1, the above described negative electrode mixture was used as a material that constitutes the negative electrode active material layer 2, and the above described solid electrolyte material 75Li₂S-25P₂S₅ was used as a material that constitutes the solid electrolyte layer 3. The power generating element 10 was used to obtain an all-solid lithium secondary battery.

### Comparative Example 1

Except that Li_{3.25}Ge_{0.25}P_{0.75}S₄ was used as the solid electrolyte material used for the positive electrode mixture, an all-solid lithium secondary battery was manufactured in the method similar to that of Example 1. The method of manufacturing the solid electrolyte material is as follows.

### Manufacturing Solid Electrolyte Material Li_{3.25}Ge_{0.25}P_{0.75}S₄

Lithium sulfide (Li₂S), germanium sulfide (GeS₂) and phosphorus pentasulfide (P₂S₅) were used as starting materials and then these were mixed at a mole ratio of 13:2:3 to obtain a material composition. Subsequently, the material composition was vacuum-encapsulated in a quartz tube and was heated at 500° C. for 10 hours. After that, the obtained fired product was milled in an agate mortar to obtain the solid electrolyte material Li_{3.25}Ge_{0.25}P_{9.75}S₄.

### Comparative Example 2

Except that a material made by coating LiCoO₂ with LiNbO₃ was used instead of the material made by coating LiCoO₂ with Li₄Ti₅O₁₂, an all-solid lithium secondary battery was manufactured in the method similar to that of Example 1. A method of manufacturing the material made by coating LiCoO₂ with LiNbO₃ is as follows.

Manufacturing Material Made by Coating LiCoO₂ with LiNbO₃

First, in ethanol, lithium ethoxide and niobium pentaethoxide were mixed at the mole ratio of 1 to 1. Subsequently, the obtained solution was applied by a coater that uses a rolling fluidized layer onto the positive, electrode active material (LiCoO₂) so as to have a thickness of 5 nm, and was then dried by hot air. After that, the obtained powder was subjected to heat treatment in the atmosphere at 400° C. for 30 minutes to obtain a material made by coating LiCoO₂ with LiNbO₃.

### Comparative Example 3

Except that 60Li₂S-40SiS₂ was used as the solid electrolyte material used for the positive electrode mixture, an all-solid lithium secondary battery was manufactured in the method similar to that of Example 1. The method of manufacturing the solid electrolyte material is as follows.

### Manufacturing Solid Electrolyte Material 60Li₂S-40SiS₂

Lithium sulfide (Li₂S) and silicon sulfide (SiS₂) were used as starting materials. The powder of Li₂S and the powder of SiS₂ were placed in a glove box in an atmosphere of argon, and were weighted to obtain the mole ratio of x=60 in the composition of xLi₂S.(100−x)SiS₂ and were then mixed in an agate mortar to thereby obtain a material composition. Then, 1 g of the obtained material composition was put into a 45 ml zirconia pot, zirconia balls (φ10 mm, 10 balls) were further put into the pot and then the pot was completely hermetically sealed. The pot was mounted on a planetary ball milling machine. Then, mechanical milling was performed at a rotational speed of 370 rpm for 40 hours. After that, the solid electrolyte material 60Li₂S-40SiS₂ was obtained.

### Evaluation 1

For the all-solid lithium secondary batteries obtained in Example 1 and Comparative examples 1 to 3, the rate of increase in the interface resistance was measured.

### Measuring Rate of Increase in Interface Resistance

First, the all-solid lithium secondary batteries were charged. Charging was carried out at a constant current of 0.1 C to 3.34 V, and then charging was carried out at a constant voltage of 3.34 V for two hours. After charging, impedance measurement was carried out to obtain the interface resistance between the positive electrode active material layer and the solid electrolyte layer. Impedance measurement was carried out at a voltage amplitude of 10 mV, a measurement frequency of 1 MHz to 0.1 Hz and a temperature of 25° C. After that, 30 cycles of charging and discharging were carried out under a discharging condition (discharged at a constant current of 0.1 C to 2 V) and a charging condition (charged at a constant current of 0.1 C to 3.58 V). Then, the rate of increase in the interface resistance was calculated from the interface resistance value after initial charging and the interface resistance value after charging in the 30th cycle. The calculated rate of increase in the interface resistance of each of the all-solid lithium secondary batteries obtained in Example 1 and Comparative examples 1 to 3 is shown in Table 1 together with the positive electrode active material, the material that coats the positive electrode active material and the solid electrolyte material.

TABLE 1

| | | | | RATE OF |
|---|---|---|---|---|
| | POSITIVE | | | INCREASE |
| | ELECTRODE | | | IN |
| | ACTIVE | COATING | | INTERFACE |
| | MATERIAL | MATERIAL | ELECTROLYTE | RESISTANCE |
| EXAMPLE 1 | LiCoO₂ | Li₄Ti₅O₁₂ | 75Li₂S—25P₂S₅ | 106 |
| COMPARATIVE | LiCoO₂ | Li₄Ti₅O₁₂ | Li_{3.25}Ge_{0.25}P_{0.75}S₄ | 179 |
| EXAMPLE 1 | | | | |
| COMPARATIVE | LiCoO₂ | LiNbO₃ | 75Li₂S—25P₂S₅ | 255 |
| EXAMPLE 2 | | | | |
| COMPARATIVE | LiCoO₂ | Li₄Ti₅O₁₂ | 60Li₂S—40SiS₂ | 162 |
| EXAMPLE 3 | | | | |

As shown in Table 1, the rate of increase in the interface resistance of Example 1 is lower than those of Comparative examples 1 to 3. The reason why the rate of increase in the interface resistance of Example 1 is lower than those of Comparative examples 1 to 3 will be described below.

The solid electrolyte material Li_{3.25}Ge_{0.25}P_{0.75}S₄ used in Comparative example 1 is crystalline and hard. Therefore, an electrode fracture occurs in the all-solid lithium secondary battery manufactured in Comparative example 1. In contrast to this, the solid electrolyte material 75Li₂S-25P₂S₅ used in Example 1 is softer than Li_{3.25}Ge_{0.25}P_{0.75}S₄, so the all-solid lithium secondary battery manufactured in Example 1 is able to prevent an electrode fracture. Therefore, it is presumed that the rate of increase in the interface resistance of Example 1 is lower than that of Comparative example 1.

The coating material LiNbO₃ used in Comparative example 2 has a low electrochemical stability. Therefore, the coating material LiNbO₃ reacts with the positive electrode active material and solid electrolyte material that are in contact with the coating material LiNbO₃ to produce a reaction product. Then, the reaction product serves as a high-resistance layer. In contrast to this, Li₄TiO₁₂ used as a coating material in Example 1 has an electrochemical stability higher than that of LiNbO₃, so Li₄Ti₅O₁₂ is hard to react with the positive electrode active material or solid electrolyte material that are in contact with Li₄Ti₅O₁₂. Therefore, it is presumed that the rate of increase in the interface resistance of Example 1 is lower than that of Comparative example 2.

The mole fraction of Li₂S in the solid electrolyte material 60Li₂S-40SiS₂ used in Comparative example 3 is 60% and is lower than a value (66.7%) for obtaining an ortho composition, so the solid electrolyte material 60Li₂S-40SiS₂ contains bridging sulfur. The solid electrolyte material 75Li₂S-25P₂S₅ used in Example 1 does not contain bridging sulfur, so it is presumed that the solid electrolyte material 75Li₂S-25P₂S₅ is chemically more stable than the solid electrolyte material 60Li₂S-40SiS₂ used in Comparative example 3. Thus, the coating material Li₄Ti₅O₁₂ is hard to react with the solid electrolyte material in Example 1 as compared with Comparative example 3, Therefore, it is presumed that the rate of increase in the interface resistance of Example 1 is lower than that of Comparative example 3.

In addition, the solid electrolyte material 60Li₂S-40SiS₂ used in Comparative example 3 is amorphous as well as the solid electrolyte material 75Li₂S-25P₂S₅ used in Example 1; however, silicon (Si) is contained instead of phosphorus (P). Therefore, it is assumed that the solid electrolyte material 60Li₂S-40SiS₂ used in Comparative example 3 is harder than the solid electrolyte material 75Li₂S-25P₂S₅ used in Example 1. Thus, it is assumed that an electrode fracture more easily occurs in the all-solid lithium secondary battery manufactured in Comparative example 3 than in the all-solid lithium secondary battery manufactured in Example 1. This is also presumed to be one factor that the rate of increase in the interface resistance of Example 1 is lower than that of Comparative example 3.

What is claimed is:

1. A solid battery comprising:
a positive electrode active material layer that includes a positive electrode active material;
a negative electrode active material layer that includes a negative electrode active material; and
a solid electrolyte layer that is formed between the positive electrode active material layer and the negative electrode active material layer, wherein
a reaction suppressing portion made of an oxide of a group 4 metallic element is formed at an interface between the positive electrode active material and an amorphous non-bridging sulfide-based solid electrolyte material that does not substantially contain bridging sulfur.

2. The solid battery according to claim 1, wherein the bridging sulfur is a chemical compound that is formed by the reaction between Li₂S and a sulfide of one of group 13 to group 15 elements.

3. The solid battery according to claim 1, wherein, when the proportion of the bridging sulfur in a material composition of the non-bridging sulfide-based solid electrolyte material is lower than a predetermined value, it is determined that the non-bridging sulfide-based solid electrolyte material does not substantially contain bridging sulfur.

4. The solid battery according to claim 1, wherein the shape of the non-bridging sulfide-based solid electrolyte material is any one of a particulate shape, a spherical shape and an ellipsoidal shape.

5. The solid battery according to claim 4, wherein the mean particle diameter of the non-bridging sulfide-based solid electrolyte material ranges from 0.1 μm to 50 μm.

6. The solid battery according to claim 1, wherein the content of the non-bridging sulfide-based solid electrolyte material in the positive electrode active material layer ranges from 1 percent by weight to 90 percent by weight.

7. The solid battery according to claim 6, wherein the content of the non-bridging sulfide-based solid electrolyte material in the positive electrode active material layer ranges from 10 percent by weight to 80 percent by weight.

8. The solid battery according to claim 1, wherein the positive electrode active material layer includes the non-bridging sulfide-based solid electrolyte material.

9. The solid battery according to claim 1, wherein the solid electrolyte layer includes the non-bridging sulfide-based solid electrolyte material.

10. The solid battery according to claim 1, wherein the reaction suppressing portion is formed so as to coat a surface of the positive electrode active material.

11. The solid battery according to claim 10, wherein the thickness of the reaction suppressing portion ranges from 1 nm to 500 nm.

12. The solid battery according to claim 11, wherein the thickness of the reaction suppressing portion ranges from 2 nm to 100 nm.

13. The solid battery according to claim 1, wherein the non-bridging sulfide-based solid electrolyte material contains one of group 13 to group 15 elements.

14. The solid battery according to claim 13, wherein the non-bridging sulfide based solid electrolyte material contains at least one of phosphorus, silicon and germanium.

15. The solid battery according to claim 14, wherein the non-bridging sulfide-based solid electrolyte material contains phosphorus.

16. The solid battery according to claim 15, wherein the non-bridging sulfide-based solid electrolyte material is made by using a material composition that contains Li₂S and P₂S₅.

17. The solid battery according to claim 1, wherein the group 4 metallic element is one of titanium and zirconium.

18. The solid battery according to claim 1, wherein the oxide of the group 4 metallic element further contains a metallic element that becomes a conducting ion.

19. The solid battery according to claim 18, wherein the metallic element that becomes a conducting ion is Li.

20. The solid battery according to claim 19, wherein the oxide of the group 4 metallic element is Li₄Ti₅O₁₂.
